(19) United States
(12) Patent Application Publication
(10) Pub. No.: US 2003/0167403 A1
(43) Pub. Date: Sep. 4, 2003

(54) SECURE USER-LEVEL TUNNELS ON THE INTERNET

(76) Inventors: KEVIN SNOW MCCURLEY, SAN JOSE, CA (US); BENJAMIN CLAY REED, SAN JOSE, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/260,448

(22) Filed: Mar. 2, 1999

(51) Int. Cl. H04L 9/00

(52) U.S. Cl. 713/201

(57) ABSTRACT

A method for network multiplexing and tunneling includes opening a single Transmission Control Protocol (TCP) connection between at least two endpoints in the network, establishing a Secure Sockets Layer (SSL) over the opened Transmission Control Protocol (TCP) connection, mutually authenticating each of the endpoints of the SSL TCP connection, and multiplexing other connections through the secure connection once both of the endpoints have been authenticated.

### BACKGROUND OF THE INVENTION

1. Field of the Invention

This invention relates in general to computer networks, and in particular, to secure user-level tunnels on the Internet.

2. Description of Related Art

(Note: This application references a number of different publications as indicated throughout the specification by reference numbers enclosed in brackets, e.g., [x]. A list of these different publications ordered according to these reference numbers can be found in the Section entitled “References” in the “Detailed Description of the Preferred Embodiment.” Each of these publications is incorporated by reference herein.)

Interest in using the Internet for commerce and interconnectivity has grown rapidly during the last few years. In addition to the development of new applications, older business applications that were designed for LAN deployment are being adapted to the Internet environment. In response to perceived security threats on the Internet, a wide variety of network security methods have been proposed or deployed. The proliferation of key management methods and passwords is imposing a large key management burden on the user.

There are a number of alternative ways to incorporate authentication and encryption into an application. The best way of categorizing the alternatives is by the layer that they operate at. In the standard OSI (Open Systems Interconnection) layered network model, a network is divided into seven layers. These layers do not map exactly to the Internet world, but they provide a helpful reference for the following discussion.

In choosing which layer to incorporate security into a network, it is helpful to think in terms of the parties that require security services. Key management is typically attached to these parties, so the association between a key and a party can best be implemented at this layer. Thus, for virtual private networks, the network layer makes the most sense, and for human interaction the application layer makes the most sense

Consider the example of an employee accessing a corporate network from the Internet. In this case, they might access a corporate web server, a Lotus Notes database, login to a Unix host, access an IMAP (Interactive Mail Access Protocol) mail server, edit files on a Microsoft NT server, or use a legacy mainframe application through a terminal application. In each case, a different authentication mechanism might be required, but it will be sent over a TCP (Transmission Control Protocol) and/or UDP (User Datagram Protocol) link from the user's machine to the appropriate corporate machine. The cacophony of authentication methods used at the application layer is part of the problem, and unifying this means changing all of the applications.

There are, however, advantages in pushing things down out of the application layer. First, many legacy applications already have their name space and weak security mechanisms already in place (e.g., local users with passwords). Moreover, the application can often be relieved of the need to maintain their own security mechanisms by aggregation at a network lower layer

At the application layer, there are numerous alternatives including DCE (Distributed Computing Environment), along with other versions of Kerberos (a security system developed at MIT that authenticates users), SSL (Secure Sockets Layer), and TLS (Transaction Layer Security). A strong option at the network layer is IPSEC (Internet Protocol Security). Some tunneling at an intermediate layer has been done already with SSH (Secure Shell) and PPTP (Point-to-Point Tunneling Protocol). Other options include L2TP (Layer 2 Tunneling Protocol) and Personal VPNs (Virtual Private Networks). The following summarizes some of the differences and relative strengths and weaknesses of these options.

PPTP was originally developed by Microsoft. The purpose of PPTP is to tunnel the PPP (Point-to-Point Protocol) through IP (Internet Protocol) packets across the Internet. PPP is ordinarily used to negotiate an IP connection across a serial modem connection. By tunneling PPP through IP, it will allow roaming machines to make PPP connections back across the Internet to a corporate network that ordinarily uses PPP for remote connections. Encryption is optional, and key management is derived from the Windows NT user registry. For sites with an investment in Windows NT and PPP, this provides a path to building virtual private networks.

PPTP was originally developed as a proprietary protocol supported by Windows NT server. A subset is now embraced by the PPTP Forum, consisting of Microsoft, Ascend, 3Com, ECI Telematics, and U.S. Robotics. This group is developing an Internet Draft [5], but as of yet it does not address security in any meaningful way.

RRAS stands for Routing and Remote Access Service. RRAS is intended to provide IP routing services and RADIUS client authentication. RRAS supports virtual private networks via Microsoft's PPTP protocol. Once again, this only runs on 32-bit Windows platforms.

SSH stands for Secure Shell, and was originally developed as a secure replacement for the UNIX remote shell (rsh). It uses asymmetric cryptographic key management to construct a secure TCP connection over which the rsh protocol can be used. A few additional services (notably, X windows and ftp) have been tunneled through SSH, but it was not intended as a tunneling protocol.

SSL (Secure Sockets Layer) is the leading security protocol on the Internet. When an SSL session is started, the browser sends its public key to the server so that the server can securely send a secret key to the browser. The browser and server exchange data via secret key encryption during that session. Developed by Netscape, SSL is expected to be merged with other protocols and authentication methods by the IETF into a new protocol known as Transaction Layer Security (TLS).

SSL started out being applied to HTTP (HyperText Transport Protocol), but it can be applied more generally to other network protocols since it maps very neatly to an encrypted socket. Numerous applications have started using SSL as their own native encryption and authentication API (application programming interface). Efforts are underway to migrate the existing Unix application base of telnet, ftp, POP (Point-Of-Presence), IMAP, rsh, SMTP (Simple Mail Transfer Protocol), and NNTP (Network News Transfer Protocol), as well as newer protocols like IIOP (Internet Inter-ORB Protocol), IRC (Internet Relay Chat), and LDAP (Lightweight Directory Access Protocol). The only one that is widely deployed at this point is NNTP over SSL.

Note also that SSL is evolving under a new name, namely TLS (Transport Layer Security). Differences from the original SSL standard are rather minor. See the Internet Draft [1]. Applications negotiating a connection under the TLS standard may revert to the SSL 3.0, but otherwise the protocols are not compatible.

SOCKS (SOCKetS server) is a generic firewall proxy server that functions as a general-purpose TCP/IP proxy. The purpose of SOCKS is to allow hosts behind a firewall to open TCP connections to the Internet, while preventing hosts on the Internet from opening connections to the protected network. SOCKS version 4 is in widespread use, and SOCKS version 5 is more recent, and adds several new functions, including UDP packet forwarding and authentication to the firewall. The latter authentication is apparently intended for the case when strong auditing or access controls are required to access the Internet from the inside network. Whatever protocol is negotiated is for the benefit of the link between the internal client machine and the SOCKS server, but not to the eventual destination host. Thus, SOCKS does not provide end-to-end encryption or authentication services. If strong authentication and encryption methods are used in SOCKS, then it can support secure remote access. Methods have been described for simple passwords, GSS-API[10, 8], SSL[12], CHAP (Challenge Handshake Authentication Protocol), and potentially others.

IPSEC stands for IP Security, which is an evolving IETF (Internet Engineering Task Force) standard for encrypting and authenticating packets that traverse the Internet. IPSEC operates at the network layer rather than the transport or application layers, and hence it is well suited to building virtual private networks between machines and networks. IPSEC has been slow to take off, and requires changes to the underlying operating system of a machine in order to function

Because encryption and authentication occurs at a low level, it takes place largely out of sight from the user. This appears very appealing at first, although it is hard for applications and users to verify that any security is actually in force when this happens. An application might someday be modified to use the proposed [11] socket API to IPSEC, but there seems to be little advantage over something like plain SSL. Moreover, because IPSEC processing takes place in the operating system, it requires changing the underlying network software layer. Experience tells us that this can be complicated to upgrade, may sometimes require upgrades to hardware, or interfere with other operating system modifications for things like SOCKS.

Moreover, the complexities of the IP protocol with source routing, fragmentation, and lossy transmission impose extra burdens on the use of authentication and encryption. For more on these problems, see [2]. The biggest problem is that trust should not be transitive, whereas IP allows various kinds of forwarding to take place.

Another potential problem with IPSEC is that it expects key negotiation to take place directly between machines, and firewalls can sometimes interfere with this direct communication. If IPSEC is used for firewall to firewall encryption and authentication (or authentication of external host to firewall), then this leaves the communication on the internal network vulnerable to eavesdropping.

Experience shows that internal network eavesdropping is one of the most likely compromises to occur, since local area broadcast networks such as Ethernet are easily accessible by insiders. In this mode, IPSEC fails to address end-to-end encryption and authentication that is required to protect against insider attacks.

As an alternative, a firewall may choose to pass packets that contain IP security headers. Note, however, that the intervening firewall is unable to validate the content of the headers, since the keys used to do this are negotiated between the endpoints of the communication. Moreover, a great deal of trust will then be placed on the internal machine, since it may choose to negotiate a key with anyone and authenticate that data is from that machine, but it must then be prepared to deal with all of the packets that it receives from that machine. For virtual private networks that is not a problem, but from hostile machines that might probe for weaknesses, this means that every service on the internal machine needs to be secure against probing. For more information on this and other interactions between firewalls and IPSEC, see [3].

Virtual private networks (VPNs) are sometimes layered inside of each other, perhaps to enforce need to know requirements within a larger organization. IPSEC makes key negotiation rather difficult in the case when layered firewalls are used, and is better suited for direct machine-to-machine security. Personal VPNs [7] are a recent proposal to remedy these shortcomings of IPSEC.

There are many ways that encryption and authentication can be incorporated into network protocols. Because encryption simply substitutes the management of confidential data for the management of confidentiality keys, the problem of handling sensitive data is not eliminated but only reduced. The real problem becomes one of key management, for which effective tools are required. More specifically, there is a need in the art for security methods that are less burdensome. The present invention comprises a network multiplexing and tunneling protocol called Usher that incorporates authentication and encryption via SSL. As a form of middleware, Usher can simplify and unify the communication security of both new and existing applications.

### SUMMARY OF THE INVENTION

To overcome the limitations in the prior art described above, and to overcome other limitations that will become apparent upon reading and understanding the present specification, the present invention discloses a method, system, article of manufacture for network multiplexing and tunneling, including opening a single Transmission Control Protocol (TCP) connection between at least two endpoints in the network, establishing a Secure Sockets Layer (SSL) over the opened Transmission Control Protocol (TCP) connection, mutually authenticating each of the endpoints of the SSL TCP connection, and multiplexing other connections through the secure connection once both of the endpoints have been authenticated.

### BRIEF DESCRIPTION OF THE DRAWINGS

Referring now to the drawings in which like reference numbers represent corresponding parts throughout:

FIG. 1 is a schematic diagram of a network where an Usher connection is created from a Portal program on a client to a Gate on a firewall bastion host that has access to an Intranet;

FIG. 2 is a schematic diagram of a network that illustrates a host inside the Intranet being accessed from a client;

FIG. 3 is a schematic diagram of a network that illustrates a host on the Internet being accessed from a client on the Internet;

FIG. 4 is a schematic diagram of a network that illustrates an Intranet being accessed by another Intranet across the Internet;

FIG. 5 is a state diagram illustrating the structures for a session in an implementation of the Usher protocol;

FIG. 6 is a state diagram illustrating the lineage of threads for an implementation of the Portal; and

FIG. 7 is a state diagram illustrating an implementation of the Usher protocol.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural and functional changes may be made without departing from the scope of the present invention.

Overview

The present invention, known as Usher, is a protocol that offers one method of managing communication keys for a user. Usher comprises a generic multiplexing network protocol that tunnels other TCP and UDP connections through a single encrypted and authenticated SSL TCP connection across a transmission media. The protocol allows for the creation and management of connections, buffering of data to ease flow control, and resolution of Internet and Intranet DNS information

When an Usher connection is created between two endpoints, a single TCP connection is opened. This is the only connection that will be used for all communications, and it stays open for the duration of the execution of the protocol. SSL is set up over the TCP connection and the two ends mutually authenticate each other using X.509 certificates. Once each side has been authenticated, the two ends begin exchanging records. All communications between the two is record based. In theory, Usher is symmetric, and either side of the tunnel can receive TCP connection requests or UDP packets destined for the tunnel.

One of the problems of a multiplexing tunnel protocol is to manage the flow control of different connections so that they do not interfere with each other. The Usher protocol takes care of this by maintaining send buffers on each end. When data arrives at the entrance to the Usher tunnel, it is forwarded through the tunnel if there is sufficient buffer space on the other end. When data arrives at the other end of the Usher tunnel, it is put in a queue for dispatch to its final destination. When data is removed from the queue and successfully written to the destination, then an acknowledgement is sent back through the Usher tunnel. In this way, Usher keeps track of how much data is buffered on the other end of the tunnel waiting to be sent. If a connection terminates, then data will stop flowing out of the buffer and the sender will eventually block.

The Usher protocol can be used in several different modes, either as a standalone proxy, a packet relay, or in conjunction with the SOCKS protocol. The Usher protocol was designed with firewalls in mind, and works in concert with the SOCKS protocol to pass safely through a firewall (both entering and leaving). Thus, Usher can be used for accomplishing various goals, such as providing secure remote access for roaming users and computers, providing virtual private networks across a public network, supporting remote administration of machines on the Internet. Usher is compatible with firewalls that conceal internal DNS (Domain Name Server) information from the outside world, because it allows host name resolution through the tunnel.

Usher serves as a form of middleware, located between the application layer (where an application might use SSL or DCE for key management) and the network layer (where IPSEC might be used). Thus, an application is relieved from the need to maintain it's own cryptographic keys, and encryption and authentication can take place at a lower communication level. Existing key management such as passwords will still work through the tunnel, but will be protected from eavesdropping over the length of the tunnel. Usher provides a flexible key management tool without requiring modifications to applications or the underlying operating system.

Uses of Usher

As a generic encrypted and authenticated tunnel, Usher can be used in a variety of modes. The two endpoints to an Usher connection are known as Portal and Gate.

Gate typically runs as a server at the entrance point to a guarded network (e.g., on a firewall bastion host computer), and must be able to communicate with both the trusted network and the untrusted network. Gate waits for incoming Usher protocol connections.

Portal typically runs on a user's machine, and makes a single TCP connection to Gate. Portal listens for incoming connections, and then forwards them to the protected network through the encrypted tunnel to Gate. Portal contains a GUI component to assist users in managing their communication, but Gate is intended to be run as an unattended server program. Portal also implements the SOCKS protocol to simplify the process of proxying communications for other programs.

The only significant difference between them is that Portal can accept new external connections destined for the tunnel, using either SOCKS or another proxy method. Gate can only create connections if they are requested through the tunnel. Obviously, both ends can also be configured to accept new connections for the tunnel, thereby providing a symmetric tunnel.

Using Usher to Access an Intranet

An Intranet generally has a trusted security model, in which all machines inside the Intranet trust each other. Access to an Intranet might take place in a variety of scenarios, including:

an employee with a laptop connects via the phone line to an Internet service provider while on the road. Large corporations may maintain their own bank of modems for this purpose, but doing so will require long distance charges or toll-free telephone charges, so many corporations try to use independent Internet service providers.

an employee may want to use a computer already connected to the Internet to connect back to the corporate Intranet. The Internet computer may be a customer's computer, a kiosk, a conference computer, a hotel computer, etc.

an employee may connect from their remote office or home, which is typically a fixed location.

Each of these scenarios implies different constraints on the nature of remote access, and has security implications. If the user is accessing a corporate network with a laptop, then provisions should be made for the eventuality that the laptop will be stolen (it has been reported that one out of seven laptops will be stolen during their lifetime). In order to prevent the computer from becoming a liability to the network, key revocation should be supported, as well as requiring user intervention to trigger a secure connection. Thus, user-level code like Usher makes as much sense as kernel-level code.

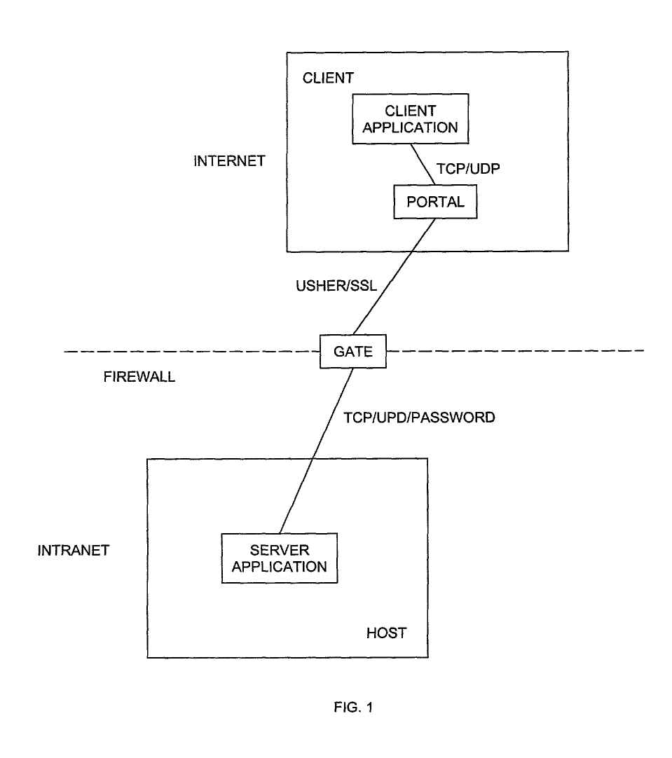

Usher can support at least two modes for accessing an Intranet from the Internet. In the first mode shown in FIG. 1, the user creates an Usher connection from a Portal program on their machine to a Gate running on a firewall bastion host computer that has access to the Intranet. The Gate has responsibility to the entire network to identify a generic user entering the network, so key management on this side is aggregated to the entire network.

Unfortunately, this mode leaves packets on the Intranet unencrypted, which is a dubious practice. Past experience shows that local area broadcast networks (e.g., Ethernet) are the most likely location for packets to be intercepted (as opposed to rerouting on a WAN). Corporate networks that send unencrypted sensitive data across their internal networks leave themselves vulnerable to insider threats and make the entire corporation only as secure as the weakest link. Given the increasing interconnectivity that the world is experiencing, people should probably be moving toward end-to-end encryption for sensitive data, so that it is not exposed at any point en route.

This is a firewall architecture problem. The purpose of a firewall is to block unsafe communications across the corporate boundary while allowing safe communications. Firewalls are made necessary by the huge installed base of insecure operating systems and LAN protocols that were never intended to be used across hostile networks. In the long run, new protocols such as IPSEC and Usher should probably be passed through firewalls, since they fall into the class of safe communications. In the short run, people are now building an installed base of firewalls that are not IPSEC aware, so the problem is going to persist in many locations

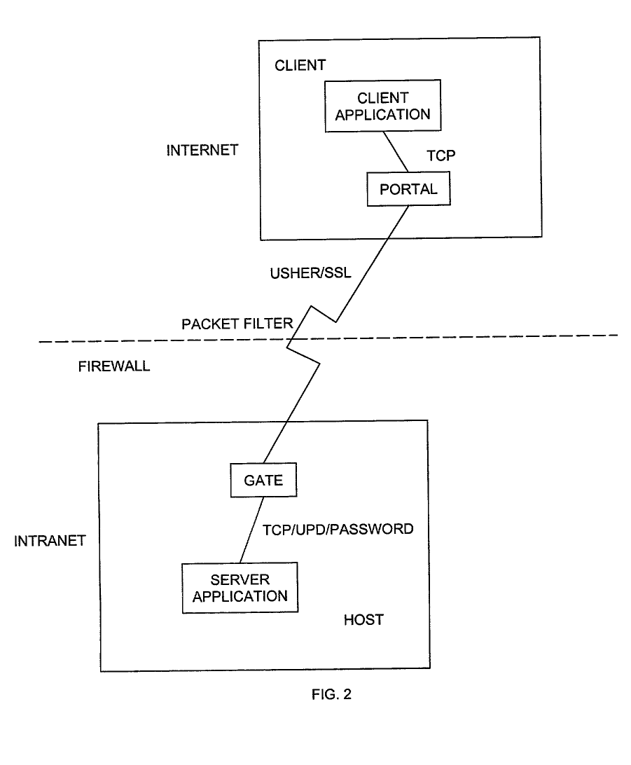

In the second mode of remote access, the firewall allows direct access to an internal host running the Usher protocol. This can be accomplished with a packet filter or proxy that allows SSL communication to a host or list of hosts that are prepared to accept Usher relays. These machines can be running a version of Gate that relays all incoming connections from the Usher tunnel to the appropriate port on the local host. Packet filtering for such an arrangement is quite simple, since all communication can take place on a recognized port such as those registered through the IANA (Internet Assigned Numbers Authority) [6]. This configuration is shown in FIG. 2.

FIG. 2 illustrates accessing a host inside the Intranet from a client on the Internet. This situation can be reversed by interchanging the Portal and Gate programs to allow a user inside the Intranet to access a server on the Internet using the Usher protocol.

If the corporate user is accessing a corporate host from a new machine, such as a hotel computer, a partner's computer, etc., then one advantage of Usher is that software may be installed quickly on these machines. Some exposure will be made because the underlying operating system may not be trustworthy, but this may be consistent with the risk assessment of the users.

Using Usher to Access the Internet from an Intranet

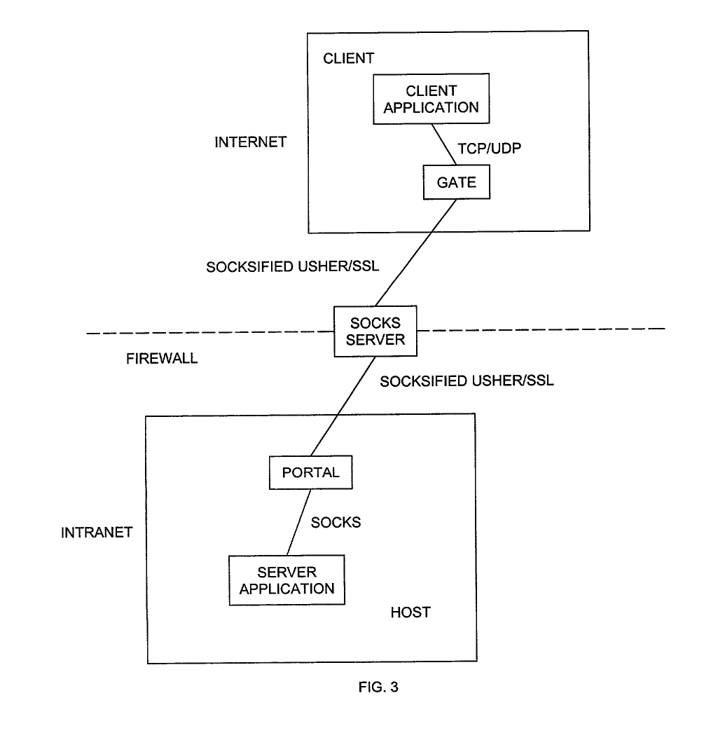

Applications on the Internet can use the Usher protocol to allow clients to enjoy encryption and authentication without modification to the client (e.g., for strong encryption where such software is not ordinarily available). In this case, the user would either be using a local Portal program on their own computer or a Portal program on a firewall bastion host computer. In the case of a local Portal, it might need to use the SOCKS protocol to establish the SSL connection to the Gate (this is supported in the Portal software). This situation is shown in FIG. 3.

FIG. 3 illustrates accessing a host on the Internet from a machine on the Internet. This configuration is the worst case because it uses too many proxies. For clients and servers that are not natively enabled to use encryption, Usher provides an alternative. Firewalls may further impose the need to perform SOCKS, resulting in many proxies. The Portal proxy on the client side can be eliminated by Usherfying the client.

If the Portal is on the firewall bastion host, then the application would either be Usherfied or would act as its SOCKS server to the Portal. In this case, the communication across the Intranet from the application to the firewall bastion host will be unencrypted, but the communication from the firewall bastion host to the Gate will be encrypted. This situation is like that of FIG. 1, except the roles of the Gate and Portal are interchanged and the roles of the client and server are interchanged. This situation can be reversed by interchanging the Portal and Gate programs to allow a user inside the Intranet to access a server on the Internet using the Usher protocol.

Using Usher in an Extranet

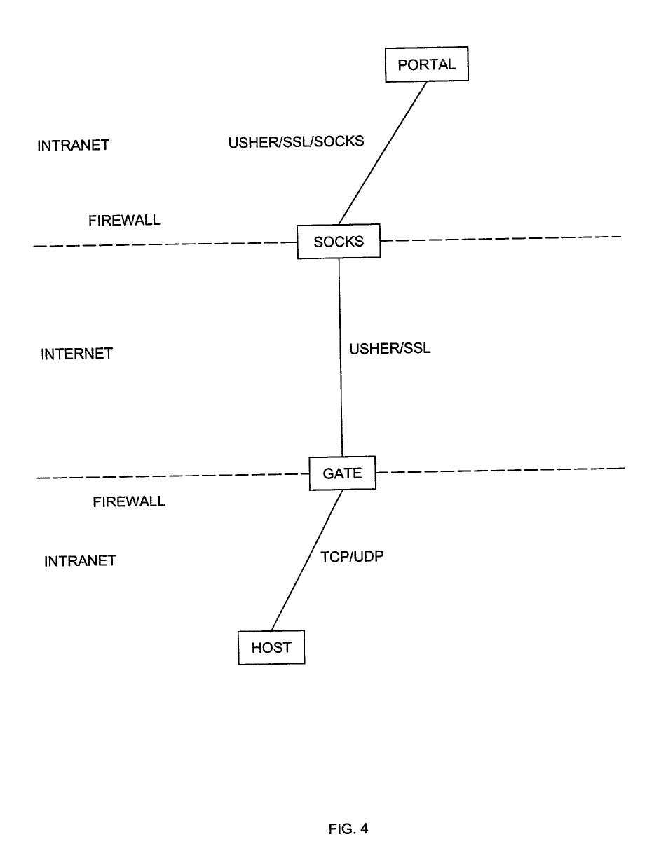

FIG. 4 illustrates accessing an Intranet from another Intranet across the Internet. Using Usher in an Extranet is similar to using Usher to access the Intranet, with the difference being that the hosts that can access the machine running Portal are trusted and Portal machines may not be able to directly access the machine running Gate. Since the machines that can access the Portal machine are trusted, the Portal machine can proxy for a machine other that the local host. Having a machine run a Portal proxy for an Intranet in one Intranet to access another across the Internet can provide an almost seamless connection of the two Intranets. SOCKS can complement Usher when the Portal machine is not connected to the Internet, in which case Portal can establish the connection with Gate by using SOCKS to cross its own firewall.

Usher Proxy

An application can be Usherfied much like an application can be “SOCKSified”; however, another useful way to use the Usher protocol is by using an Usher proxy like Portal. An Usher proxy works by making a connection to Gate and then listening on specific UDP and TCP ports and forwarding packets and connections received on the ports to a machine on the other side of the firewall. For example, in this way, an Usher proxy can listen for DNS requests, forward them to a machine inside the Intranet, and effectively bridge the DNS service. Another way is to listen for inbound telnet connections, request their destination, and forward their connection to the appropriate destination through the Usher tunnel.

Security Considerations

Data that enters the Usher tunnel should be restricted to the party for whom service is being provided. In particular, if it is set up as a SOCKS or proxy server, then it should only be serving connections from a trusted network (or from a user's machine). This is particularly troublesome with UDP packets, for which the return address is completely untrustworthy. In the scenarios that will probably use Usher, Portal will be run on a machine with a single user and will only accept connections from local applications. It is also not a problem if Portal is running on an Intranet where all hosts are trusted equally.

Description of Data Structures

There are seven types of data structures or records used in the Usher protocol: UsherOpen, UsherOpenReply, UsherSend, UsherClose, UsherSendUdp, UsherAck, and UsherEnd. All of the records start with eight bytes, wherein the first four bytes are the length of the record, the next two bytes are the record type, and the final two bytes are the session identifier. (All numbers are big-endian.)

UsherOpen

The UsherOpen record is sent by Portal to Gate to open a TCP connection on its behalf. Following is the C-structure for the UsherOpen record:

STRUCT USHEROPEN{

INT32 LENGTH;
INT16 TYPE;
INT16 SESSION;
INT16 PROTOCOL;
INT16 ADDRTYPE;
INT16 PORT;
UNION {

INT32 IPV4;
CHAR HOSTNAME[1];

} ADDR;

};

These fields are described below:

LENGTH is the length of the record following the header.

TYPE is the record type, which is 1.

SESSION is a new identifier that will be used by Portal to represent the connection being requested. This id will be used by Gate to assist UsheropenReply, UsherSend, and UsherClose packets for this connection.

PROTOCOL is the protocol to be used.

ADDRTYPE is the address type being used. If the address type is 1 (IPV4), the address is represented as 4 bytes. If the address type is 2 (HOSTNAME), the address is represented as a null terminated string.

PORT is the port to connect to.

ADDR is the address, which is a null terminated string if the address type is HOSTNAME or a 4 byte IP address if the address type is IPV4.

UsherOpenReply

Gate responds to UsherOpen using UsherOpenReply. Following is the C-structure for the UsherOpenReply record:

STRUCT USHEROPENREPLY{

INT32 LENGTH;
INT16 TYPE;
INT16 SESSION;
INT16 RC;
CHAR REASON[1];
};

These fields are described below:

LENGTH is the length of the record.

TYPE is the record type, which is −1.

SESSION is the session identifier is the id of the session that issued the UsherOpen.

RC is the return code. If the return code is −1, the connection failed; otherwise, the return code is the session identifier of the connection on Gate which will be used by Portal for sending UsherSend and UsherClose records. If the connection falls, the return code will be followed by a null terminated string (REASON) telling the reason for the failure.

UsherSend

Once the connection has been made, either Portal or Gate can send UsherSend packets. Following is the C-structure representing the UsherSend packet:

STRUCT USHERSEND{

INT32 LENGTH;
INT16 TYPE;
INT16 SESSION;
CHAR DATA[1];

};

These fields are described below:

LENGTH is the length of the record following the header.

TYPE is the record type, which is 3.

DATA is the UsherSend packet to be sent/received on the connection.

UsherAck

All data sent through the Usher tunnel is acknowledged via UsherAck packets, so that the other side of the Usher tunnel can know how much data is buffered. In other words, if Portal or Gate receives an UsherSend and is not able to process the send (e.g., the TCP send buffer is full), it must be buffered until it can be processed. When a block of data is sent, an UsherAck is sent to the other party, wherein the UsherAck includes the session number and the count of bytes that were sent.

Following is the C-structure representing the UsherAck packet:

STRUCT USHERACK{

INT32 LENGTH;
INT16 TYPE;
INT16 SESSION;
INT16 SIZE;

};

These fields are described below:

LENGTH is the length of the record following the header.

TYPE is the record type, which is 5.

SESSION is the session identifier is the id of the session that issued the UsherOpen.

SIZE is the number of bytes that were sent.

UsherClose

The UsherClosed is sent whenever one side of the protocol has reason to close the session. A TCP connection may be thought of as two unidirectional connections [9]. It is considered closed when both sides say they have stopped writing. It may also be closed when one side says it has stopped writing and reading, but this is a signal of an error condition when one side decides to stop listening without being told to do so by the other side.

In order to provide this functionality, a session can be closed in either direction, and the direction being closed should be indicated in the packet. All resources for a session may be released on an endpoint when it has received indication that no further data will flow in either direction, and it has evidence that the other side agrees to this (because UsherClose records that were received or sent). A connection can be closed because it detects an error condition or because a normal close has been received on the socket. In the case of a normal socket close, the other side should be given the chance to finish sending all data that is currently in the pipeline.

Following is the C-structure representing the UsherClose:

STRUCT USHERCLOSE{

INT32 LENGTH;
INT16 TYPE;
INT16 SESSION;
INT16 DIRECTION;

};

These fields are described below:

LENGTH is the length of the record following the header.

TYPE is the record type, which is 2.

SESSION is the session identifier is the id of the session that issued the UsherOpen.

DIRECTION may take on one of three values: USHER_READ=0, USHER_WRITE=1, or USHER_BOTH=2. If one side sends an UsherClose with direction of USHER_READ, then it means they have stopped reading their socket so they will not be sending any more data through the Usher tunnel. This is equivalent to the TCP ABORT event, and informs the other side that they should stop writing any further data on their end- These values correspond to the customary values used by the Unix socket shutdown( ) call.

UsherSendUdp

To send UDP packets, both Portal and Gate use UsherSendUdp packets. Following is the C-structure representing the UsherSendUdp.

STRUCT USHERSENDUDP{

INT32 LENGTH;
INT16 TYPE;
INT16 SESSION;
INT32 ADDR;
INT16 PORT;
INT32 REMOTEADDR;
INT16 REMOTEPORT;
CHAR DATA[1];

};

These fields are described below:

LENGTH is the length of the record following the header.

TYPE is the record type, which is 4.

SESSION is the session identifier is the id of the session that issued the UsherOpen.

ADDR is the IP address type of the host that is sending the packet.

PORT is the port that sent the packet.

REMOTEADDR is the IP address type of the host to which the packet is destined.

REMOTEPORT is the port that to which the packet is destined.

DATA is the data packet.

UsherEnd

Either side can send an UsherEnd packet, resulting in a complete shutdown of the connection and loss of all pending data. The only value in this is to allow either side to clean up resources and report a reason for dropping the connection. Unlike a TCP connection, for which half (one direction) of the connection can be closed, Usher only allows a complete shutdown of a connection.

Following is the C-structure for the UsherEnd record

STRUCT USHEREND{

INT32 LENGTH;
INT16 TYPE;
INT16 SESSION;
CHAR REASON[1];

};

These fields are described below:

LENGTH is the length of the record following the header.

TYPE is the record type, which is 6.

SESSION is the identifier of the connection.

REASON is an indicator of why the connection is being closed.

UsherRST

Either side can send an UsherRST packet, resulting in a reset of the session and a flush of all queued data packets.

Following is the C-structure for the UsherRST record

STRUCT USHEREND{

INT32 LENGTH;
INT16 TYPE;
INT16 SESSION;
CHAR REASON[1];

};

These fields are described below:

LENGTH is the length of the record following the header.

TYPE is the record type, which is 7.

SESSION is the identifier of the connection.

REASON is an indicator of why the connection is being reset.

Session Structure

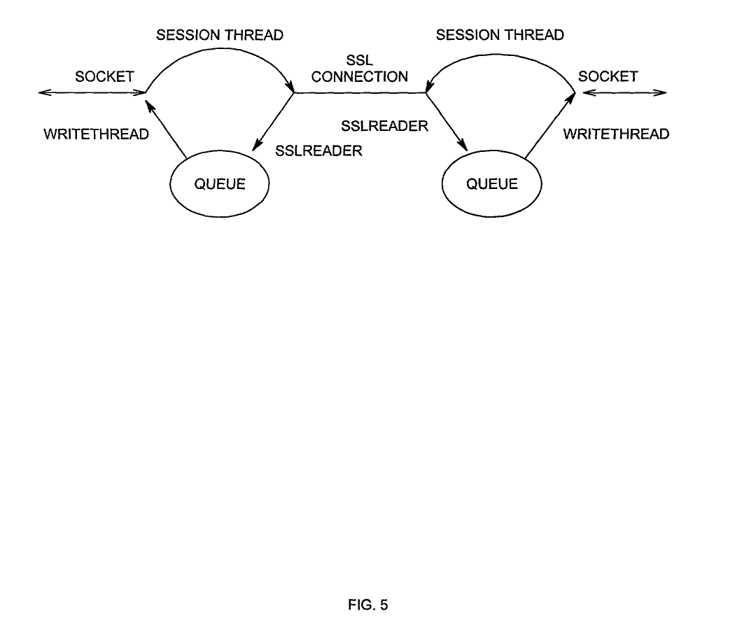

FIG. 5 illustrates the structures for an Usher session. In the Usher protocol, handing off data from a client to the Usher stream is handled by a separate thread. Reading it back is handled by yet another thread. This means that each individual TCP connection requires four threads (two on each end).

In addition, an SSLreader thread is maintained on each end of the SSL connection to read packets out and act on them. SSLreader places packets for an existing session into the queue for that session. When a session is created, four new threads are created, consisting of a Session and a WriteThread for each side. WriteThread takes packets out of the queue and writes them to the outbound socket, while Session reads packets from the socket and writes them to the SSL connection

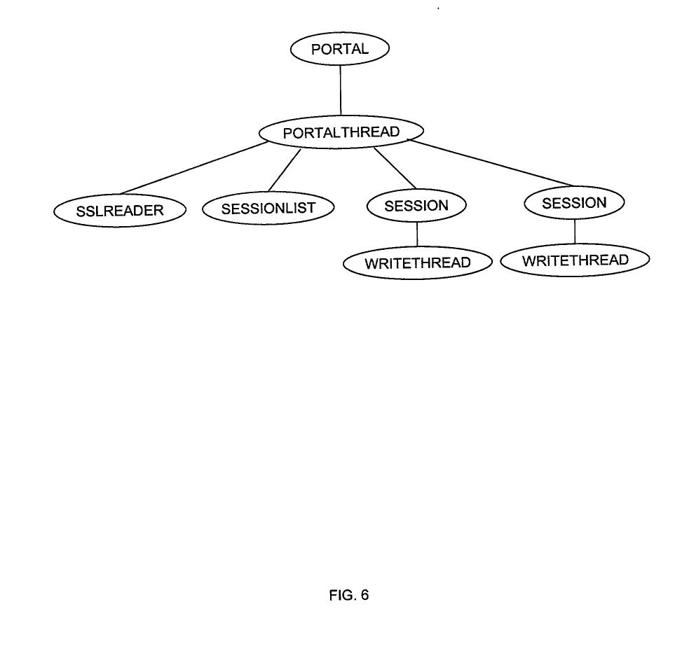

Finally, both Gate and Portal maintain a “janitor” thread called SessionList to clean up sessions that are finished. A session may die for a variety of reasons, including a read error, a write error, an UsherClose received, or an external event. A Session/WriteThread pair can be stopped by a number of threads (perhaps simultaneously), and the function of the SessionList thread is to clean up after these after they have finished. In addition, it is possible to implement a timeout feature this way. The lineage of threads in the implementation of Portal is shown in FIG. 6. For the Gate program, the only difference is that there is no counterpart to the PortalThread (whose only purpose is to release the top level Portal to handle GUI events) and Sessions are started by SSLreader in response to UsherOpen packets

State Diagram

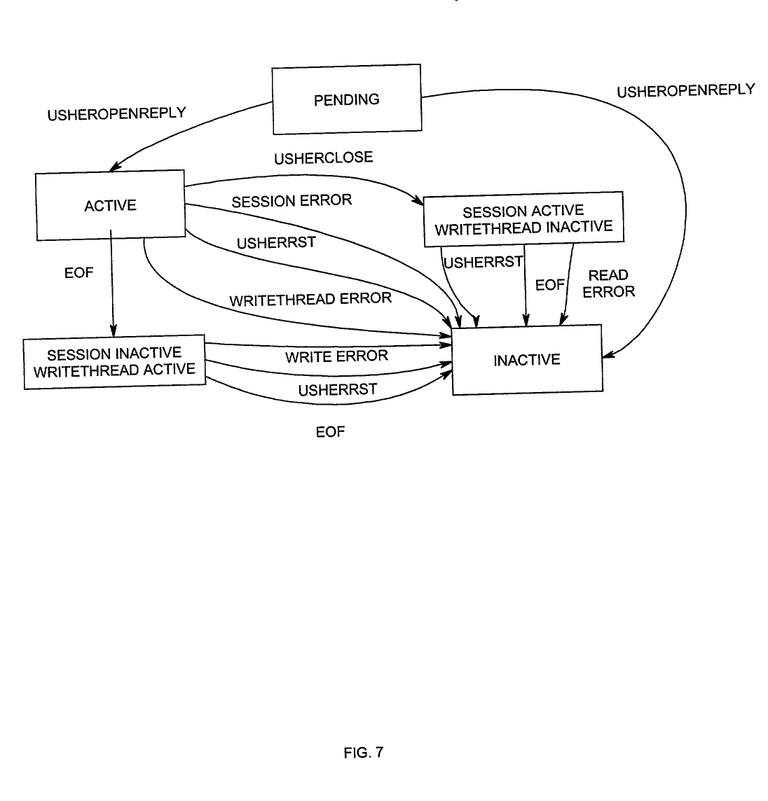

There are some subtleties in the implementation of the Usher protocol that are worth explaining. TCP has a rather complicated state diagram in order to keep both sides in agreement on which connections are open. By contrast, the Usher protocol has a somewhat simpler state diagram since the connection between two endpoints can be assumed to exist via TCP. An Usher session can be in one of five possible states: pending, active, Session active, WriteThread active, and inactive. The possible transitions between the different states are illustrated in FIG. 7.

FIG. 7 is a state diagram for an implementation of the Usher protocol. Transitions between states are triggered by conditions such as an I/O error, and end-of-file (EOF), or an Usher Reset (RST).

The possible phase transitions are:

from “Inactive”

to “active” when an affirmative UsherOpenReply is received,

to “inactive” when a negative UsherOpenReply is received,

from “active”

to “WriteThread active” when an end-of-file is received on the session socket,

to “session active” when an UsherClose is received,

to “inactive” when an UsherRST is received,

to “inactive” when a read error occurs in the Session thread,

to “inactive” when a write error occurs in the WriteThread,

from “WriteThread active”

to “inactive” when a write error occurs on the socket,

to “inactive” when an UsherClose is received,

to inactive” when an UsherRST packet is received,

from “session active”

to “inactive” when a read error occurs on the socket,

to “inactive” when an end of file is detected on the socket,

to “inactive” when an UsherRST packet is received.

References

The following references are incorporated by reference herein:

[1] C. Allen and T. Dierks, TLS Protocol Version 1.0, Internet Draft draft-ietf-tls-protocol-04-txt, Oct. 29, 1007. Available online at http://info.internet-isi-edu-80/in-drafts/files/draft-ietf-tls-protocol-04.txt.

[2] Steve Bellovin, “Problem Areas for the IP Security Protocols”, USENIX Security Conference, 1996. Available from ftp://ftp.research.att.com/dist/amb/badesp.ps.

[3] Uwe Ellermann, “IPv6 and Firewalls”, available from DFN CERT at http://www.cert.dfu.de/eng/team/ue/fw/ipv6fw/home.html.

[4] Alan O. Freier, Philip Karlton, Paul C. Kocher, “The SSL Protocol Version 3.0”, Internet Draft draft-freier-ssl-version3-02, Nov. 18, 1996, available at http://cgi.de.netscape.com/eng/ssl3/draft302.txt.

[5] Kory Hamzeh, Gurdeep Singh Pall, William Verthein, Jeff Taarud, and W. Andrew Little, “Point-to-point Tunneling Protocol-PPTP”, Internet Draft draft-ietf-ppext-pptp-02, available at http://info.internet.isi.edu:80/in-drafts/files/draft-ietf-pppext-pptp-02.txt.

[6] Internet Assigned Number Authority, “Directory of Assigned TCP/UDP Port Numbers”, available online from ftp://ftp.isi.edu/innotes/iana/assignments/port-numbers.

[7] Makoto Kayazhima, Minoru Koizumi, Tatsuya Fujiyama, Masato Terada, and Kazunari Hirayama, “Seamless VPN”, Proceedings of INET '97, Internet Society, June 1997. See http://www.isoc.org/ftp/inet97/6652/.

[8] M. Leech, et al, Internet RFC 1928, “SOCKS Protocol Version 5”, March 1996. Available online from http://info.internet.isi.edu-80/in-notes/rfc/files/rfc1928.txt.

[9] Jon Postel, Internet RFC 793, “Transmission Control Protocol”, September 1981. Available online from http://info.internet.isi.edu-80/in-notes/rfc/files/rfc793.txt.

[10] P. McMahon, Internet RFC, 1961, “GSS-API Authentication Method for SOCKS Version 5”, June 1996. Available from http://info.internet.isi.edu-80/in-notes/rfc/files/rfc1961.txt.

[11] D. L. McDonald, “A Simple IP Security API Extension to BSD Sockets”, Internet Draft draft-mcdonald-simple-ipsec-api-01.txt, available at http://globecom.net/(nobg)/ietf/draft/draft-mcdonald-simple-ipsec-api-01.shtml.

[12] M VanHeyningen, “Secure Sockets Layer for SOCKS Version 5”, Internet Draft draft-ietf-aft-SOCKS-ssl-00, available at http://info.internet.isi-edu:80/in-drafts/files/draft-ietf-aft-SOCKS-ssl-00-txt.

### CONCLUSION

This concludes the description of the preferred embodiment of the invention. The following describes some alternative embodiments for accomplishing the present invention. For example, any type of computer, such as a mainframe, minicomputer, or personal computer, could be used with the present invention. In addition, any type of network, such as the Internet, intranet, extranet, wide-area network, local area network, etc., could benefit from the present invention.

In summary, the present invention discloses a method, system, and article of manufacture a method, system, article of manufacture for network multiplexing and tunneling, including opening a single Transmission Control Protocol (TCP) connection between at least two endpoints in the network, establishing a Secure Sockets Layer (SSL) over the opened Transmission Control Protocol (TCP) connection, mutually authenticating each of the endpoints of the SSL TCP connection, and multiplexing other connections through the secure connection once both of the endpoints have been authenticated.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A network multiplexing and tunneling system, comprising at least two devices connected across a network by a secure connection created at a user-level, wherein the secure connection is a single encrypted Secure Sockets Layer (SSL) Transmission Control Protocol (TCP) connection, each of the devices authenticates the other device after the secure connection is opened, and at least one of the devices multiplexes other connections through the secure connection after both the devices have been authenticated.

2. The system of claim 1, wherein the other connections are selected from a group comprising Transmission Control Protocol (TCP) and UDP (User Datagram Protocol) connections.

3. The system of claim 1, wherein the secure connection is symmetric.

4. The system of claim 1, wherein either endpoint of the secure connection can receive connection requests.

5. The system of claim 1, wherein either endpoint of the secure connection can receive data.

6. The system of claim 1, further comprising means for maintaining send buffers on each endpoint.

7. The system of claim 1, further comprising means for forwarding data through the secure connection when there are sufficient send buffers for receiving the forwarded data on the other endpoint.

8. The system of claim 1, further comprising means for queuing data received at each endpoint.

9. The system of claim 8, further comprising means for dispatching the queued data at each endpoint to its final destination.

10. The system of claim 9, further comprising means for acknowledging receipt of the data after the queued data is dispatched to its final destination, thereby tracking usage of buffers at the endpoint.

11. The system of claim 1, further comprising means for buffering data transmitted through the multiplexed other connections for flow control through the secure connection.

12. The system of claim 1, further comprising means for resolving domain names through the secure connection.

13. The system of claim 1, further comprising means for operating the secure connection according to a mode selected from a group comprising a standalone proxy mode, a packet filter mode, and a SOCKetS server (SOCKS) mode.

14. The system of claim 1, wherein the endpoints comprise a Portal and a Gate.

15. The system of claim 14, wherein the Gate comprises a server executed by a firewall bastion host computer.

16. The system of claim 14, wherein the Portal comprises a client executed by a user's computer.

17. The system of claim 1, further comprising means for accessing an Intranet from the Internet using the secure connection.

18. The system of claim 17, further comprising means for creating a connection from a Portal on a client computer on the Internet to a Gate on a firewall bastion host computer on the Intranet through the secure connection.

19. The system of claim 17, further comprising means for creating a connection from a Portal on a client computer on the Internet to a proxy on a firewall bastion host computer on the Intranet through the secure connection and from the proxy to a Gate on a host computer on the Intranet through the secure connection.

20. The system of claim 17, further comprising means for creating a connection from a Portal on a client computer on the Internet to a packet filter on a firewall bastion host computer on the Intranet through the secure connection and from the packet filer to a Gate on a host computer on the Intranet through the secure connection.

21. The system of claim 1, further comprising means for accessing the Internet from a n Intranet using the secure connection.

22. The system of claim 21, further comprising means for creating a connection from a Portal on a client computer on the Intranet to a Gate on a host computer on the Internet through the secure connection.

23. The system of claim 21, further comprising means for creating a connection from a Portal on a firewall bastion host computer on the Intranet to a host computer on the Internet through the secure connection.

24. The system of claim 21, further comprising means for creating a connection from a Portal on a client computer on the Intranet to a proxy on a firewall bastion host computer on the Intranet through the secure connection and from the proxy to a Gate on a host computer on the Internet through the secure connection.

25. The system of claim 21, further comprising means for creating a connection from a Portal on a client computer on the Intranet to a packet filter on a firewall bastion host computer on the Intranet through the secure connection and from the packet filer to a Gate on a host computer on the Internet through the secure connection.

26. The system of claim 1, further comprising means for accessing a first Intranet from a second Intranet across the Internet using the secure connection.

27. The system of claim 26, further comprising means for creating a connection from a Portal on a client computer on the first Intranet to a Gate on a firewall bastion host computer on the first Intranet through the secure connection, and from the Gate on the firewall bastion host computer on the first Intranet through the Internet to a Gate on a firewall bastion host computer on the second Intranet through the secure connection, and from the Gate on the firewall bastion host computer on the second Intranet to a host computer on the second Intranet through the secure connection.

28. The system of claim 1, wherein records are exchanged between the endpoints of the secure connection.

29. The system of claim 28, wherein the records are selected from a group comprising: UsherOpen, UsherOpenReply, UsherSend, UsherClose, UsherSendUdp, UsherAck, UsherEnd, and UsherRST records.

30. The system of claim 29, wherein the UsherOpen records are sent by a Portal to a Gate to open a Transmission Control Protocol (TCP) connection.

31. The system of claim 29, wherein the UsherOpenReply records are sent by a Gate to a Portal to respond to an UsherOpen record.

32. The system of claim 29, wherein the UsherSend records are sent by either a Gate or a Portal to transmit data therebetween.

33. The system of claim 29, wherein the UsherAck records are sent by either a Gate or a Portal to acknowledge a receipt of data therebetween.

34. The system of claim 29, wherein the UsherAck records are not send when data received by either a Gate or a Portal is queued prior to being forwarded to its destination.

35. The system of claim 29, wherein the UsherAck records are sent only when data received by either a Gate or a Portal has been forwarded to its destination.

36. The system of claim 29, wherein the UsherClose records are sent by either a Gate or a Portal to terminate a session.

37. The system of claim 29, wherein the UsherSendUdp records are sent by either a Gate or a Portal to transmit UDP (User Datagram Protocol) packets therebetween.

38. The system of claim 29, wherein the UsherEnd records are sent by either a Gate or a Portal to terminate a multiplexed other connection.

39. The system of claim 29, wherein the UsherRST records are sent by either a Gate or a Portal to reset a multiplexed other connection.

40. A transmission media communicating data via a secure connection created at a user-level between two endpoints in a network, wherein the secure connection is a single encrypted Secure Sockets Layer (SSL) Transmission Control Protocol (TCP) connection, each of the endpoints authenticates the other device after the secure connection is opened, and at least one of the endpoints multiplexes other connections through the secure connection after both the endpoints have been authenticated.

41. The transmission media of claim 40, wherein the other connections are selected from a group comprising Transmission Control Protocol (TCP) and UDP (User Datagram Protocol) connections.

42. The transmission media of claim 40, wherein the secure connection is symmetric.

43. The transmission media of claim 40, wherein either endpoint of the secure connection can receive connection requests.

44. The transmission media of claim 40, wherein either endpoint of the secure connection can receive data.

45. The transmission media of claim 40, further comprising maintaining send buffers on each endpoint.

46. The transmission media of claim 40, further comprising forwarding data through the secure connection when there are sufficient send buffers for receiving the forwarded data on the other endpoint.

47. The transmission media of claim 40, further comprising queuing data received at each endpoint.

48. The transmission media of claim 47, further comprising dispatching the queued data at each endpoint to its final destination.

49. The transmission media of claim 48, further comprising acknowledging receipt of the data after the queued data is dispatched to its final destination, thereby tracking usage of buffers at the endpoint.

50. The transmission media of claim 40, further comprising buffering data transmitted through the multiplexed other connections for flow control through the secure connection.

51. The transmission media of claim 40, further comprising resolving domain names through the secure connection.

52. The transmission media of claim 40, further comprising operating the secure connection according to a mode selected from a group comprising a standalone proxy mode, a packet filter mode, and a SOCKetS server (SOCKS) mode.

53. The transmission media of claim 40, wherein the endpoints comprise a Portal and a Gate.

54. The transmission media of claim 53, wherein the Gate comprises a server executed by a firewall bastion host computer.

55. The transmission media of claim 53, wherein the Portal comprises a client executed by a user's computer.

56. The transmission media of claim 40, further comprising accessing an Intranet from the Internet using the secure connection.

57. The transmission media of claim 56, further comprising creating a connection from a Portal on a client computer on the Internet to a Gate on a firewall bastion host computer on the Intranet through the secure connection.

58. The transmission media of claim 56, further comprising creating a connection from a Portal on a client computer on the Internet to a proxy on a firewall bastion host computer on the Intranet through the secure connection and from the proxy to a Gate on a host computer on the Intranet through the secure connection.

59. The transmission media of claim 56, further comprising creating a connection from a Portal on a client computer on the Internet to a packet filter on a firewall bastion host computer on the Intranet through the secure connection and from the packet filer to a Gate on a host computer on the Intranet through the secure connection.

60. The transmission media of claim 40, further comprising accessing the Internet from an Intranet using the secure connection.

61. The transmission media of claim 60, further comprising creating a connection from a Portal on a client computer on the Intranet to a Gate on a host computer on the Internet through the secure connection.

62. The transmission media of claim 60, further comprising creating a connection from a Portal on a firewall bastion host computer on the Intranet to a host computer on the Internet through the secure connection.

63. The transmission media of claim 60, further comprising creating a connection from a Portal on a client computer on the Intranet to a proxy on a firewall bastion host computer on the Intranet through the secure connection and from the proxy to a Gate on a host computer on the Internet through the secure connection.

64. The transmission media of claim 60, further comprising creating a connection from a Portal on a client computer on the Intranet to a packet filter on a firewall bastion host computer on the Intranet through the secure connection and from the packet filer to a Gate on a host computer on the Internet through the secure connection.

65. The transmission media of claim 40, further comprising accessing a first Intranet from a second Intranet across the Internet using the secure connection.

66. The transmission media of claim 65, further comprising creating a connection from a Portal on a client computer on the first Intranet to a Gate on a firewall bastion host computer on the first Intranet through the secure connection, and from the Gate on the firewall bastion host computer on the first Intranet through the Internet to a Gate on a firewall bastion host computer on the second Intranet through the secure connection, and from the Gate on the firewall bastion host computer on the second Intranet to a host computer on the second Intranet through the secure connection.

67. The transmission media of claim 40, wherein records are exchanged between the endpoints of the secure connection.

68. The transmission media of claim 67, wherein the records are selected from a group comprising: UsherOpen, UsherOpenReply, UsherSend, UsherClose, UsherSendUdp, UsherAck, UsherEnd, and UsherRST records.

69. The transmission media of claim 68, wherein the UsherOpen records are sent by a Portal to a Gate to open a Transmission Control Protocol (TCP) connection.

70. The transmission media of claim 68, wherein the UsherOpenReply records are sent by a Gate to a Portal to respond to an UsherOpen record.

71. The transmission media of claim 68, wherein the UsherSend records are sent by either a Gate or a Portal to transmit data therebetween.

72. The transmission media of claim 68, wherein the UsherAck records are sent by either a Gate or a Portal to acknowledge a receipt of data therebetween.

73. The transmission media of claim 68, wherein the UsherAck records are not send when data received by either a Gate or a Portal is queued prior to being forwarded to its destination.

74. The transmission media of claim 68, wherein the UsherAck records are sent only when data received by either a Gate or a Portal has been forwarded to its destination.

75. The transmission media of claim 68, wherein the UsherClose records are sent by either a Gate or a Portal to terminate a session.

76. The transmission media of claim 68, wherein the UsherSendUdp records are sent by either a Gate or a Portal to transmit UDP (User Datagram Protocol) packets therebetween.

77. The transmission media of claim 68, wherein the UsherEnd records are sent by either a Gate or a Portal to terminate a multiplexed other connection.

78. The transmission media of claim 68, wherein the UsherRST records are sent by either a Gate or a Portal to reset a multiplexed other connection.

79. A method for network multiplexing and tunneling, comprising:
(a) opening a single Transmission Control Protocol (TCP) connection at a user-level between at least two endpoints in the network;
(b) establishing a Secure Sockets Layer (SSL) over the opened Transmission Control Protocol (TCP) connection;
(c) mutually authenticating each of the endpoints of the SSL TCP connection; and
(d) multiplexing other connections through the secure connection once both of the endpoints have been authenticated.

80. The method of claim 79, wherein the other connections are selected from a group comprising Transmission Control Protocol (TCP) and UDP (User Datagram Protocol) connections.

81. The method of claim 79, wherein the secure connection is symmetric.

82. The method of claim 79, wherein either endpoint of the secure connection can receive connection requests.

83. The method of claim 79, wherein either endpoint of the secure connection can receive data.

84. The method of claim 79, further comprising maintaining send buffers on each endpoint.

85. The method of claim 79, further comprising forwarding data through the secure connection when there are sufficient send buffers for receiving the forwarded data on the other endpoint.

86. The method of claim 79, further comprising queuing data received at each endpoint.

87. The method of claim 86, further comprising dispatching the queued data at each endpoint to its final destination.

88. The method of claim 87, further comprising acknowledging receipt of the data after the queued data is dispatched to its final destination, thereby tracking usage of buffers at the endpoint.

89. The method of claim 79, further comprising buffering data transmitted through the multiplexed other connections for flow control through the secure connection.

90. The method of claim 79, further comprising resolving domain names through the secure connection.

91. The method of claim 79, further comprising operating the secure connection according to a mode selected from a group comprising a standalone proxy mode, a packet filter mode, and a SOCKetS server (SOCKS) mode.

92. The method of claim 79, wherein the endpoints comprise a Portal and a Gate.

93. The method of claim 92, wherein the Gate comprises a server executed by a firewall bastion host computer.

94. The method of claim 92, wherein the Portal comprises a client executed by a user's computer.

95. The method of claim 79, further comprising accessing an Intranet from the Internet using the secure connection.

96. The method of claim 95, further comprising creating a connection from a Portal on a client computer on the Internet to a Gate on a firewall bastion host computer on the Intranet through the secure connection.

97. The method of claim 95, further comprising creating a connection from a Portal on a client computer on the Internet to a proxy on a firewall bastion host computer on the Intranet through the secure connection and from the proxy to a Gate on a host computer on the Intranet through the secure connection.

98. The method of claim 95, further comprising creating a connection from a Portal on a client computer on the Internet to a packet filter on a firewall bastion host computer on the Intranet through the secure connection and from the packet filer to a Gate on a host computer on the Intranet through the secure connection.

99. The method of claim 79, further comprising accessing the Internet from an Intranet using the secure connection.

100. The method of claim 99, further comprising creating a connection from a Portal on a client computer on the Intranet to a Gate on a host computer on the Internet through the secure connection.

101. The method of claim 99, further comprising creating a connection from a Portal on a firewall bastion host computer on the Intranet to a host computer on the Internet through the secure connection.

102. The method of claim 99, further comprising creating a connection from a Portal on a client computer on the Intranet to a proxy on a firewall bastion host computer on the Intranet through the secure connection and from the proxy to a Gate on a host computer on the Internet through the secure connection.

103. The method of claim 99, further comprising creating a connection from a Portal on a client computer on the Intranet to a packet filter on a firewall bastion host computer on the Intranet through the secure connection and from the packet filer to a Gate on a host computer on the Internet through the secure connection.

104. The method of claim 79, further comprising accessing a first Intranet from a second Intranet across the Internet using the secure connection.

105. The method of claim 104, further comprising creating a connection from a Portal on a client computer on the first Intranet to a Gate on a firewall bastion host computer on the first Intranet through the secure connection, and from the Gate on the firewall bastion host computer on the first Intranet through the Internet to a Gate on a firewall bastion host computer on the second Intranet through the secure connection, and from the Gate on the firewall bastion host computer on the second Intranet to a host computer on the second Intranet through the secure connection.

106. The method of claim 79, wherein records are exchanged between the endpoints of the secure connection.

107. The method of claim 106, wherein the records are selected from a group comprising: UsherOpen, UsherOpenReply, UsherSend, UsherClose, UsherSendUdp, UsherAck, UsherEnd, and UsherRST records.

108. The method of claim 107, wherein the UsherOpen records are sent by a Portal to a Gate to open a Transmission Control Protocol (TCP) connection.

109. The method of claim 107, wherein the UsherOpenReply records are sent by a Gate to a Portal to respond to an UsherOpen record.

110. The method of claim 107, wherein the UsherSend records are sent by either a Gate or a Portal to transmit data therebetween.

111. The method of claim 107, wherein the UsherAck records are sent by either a Gate or a Portal to acknowledge a receipt of data therebetween.

112. The method of claim 107, wherein the UsherAck records are not send when data received by either a Gate or a Portal is queued prior to being forwarded to its destination.

113. The method of claim 107, wherein the UsherAck records are sent only when data received by either a Gate or a Portal has been forwarded to its destination.

114. The method of claim 107, wherein the UsherClose records are sent by either a Gate or a Portal to terminate a session.

115. The method of claim 107, wherein the UsherSendUdp records are sent by either a Gate or a Portal to transmit UDP (User Datagram Protocol) packets therebetween.

116. The method of claim 107, wherein the UsherEnd records are sent by either a Gate or a Portal to terminate a multiplexed other connection.

117. The method of claim 107, wherein the UsherRST records are sent by either a Gate or a Portal to reset a multiplexed other connection.
